(19) United States
(12) Patent Application Publication
(10) Pub. No.: US 2009/0135525 A1
(43) Pub. Date: May 28, 2009

(54) Suspension, head gimbal assembly, and disk drive unit with the same

(75) Inventor: Huai Yang, Dong Guan (CN)

Correspondence Address: NIXON & VANDERHYE, PC, 901 NORTH GLEBE ROAD, 11TH FLOOR, ARLINGTON, VA, 22203, US

(73) Assignee: SAE Magnetics (H.K.) Ltd., Hong Kong (CN)

(21) Appl. No.: 11/984,926

(22) Filed: Nov. 26, 2007

(51) Int. Cl. G11B 5/56

(52) U.S. Cl. 360/294.4

(57) ABSTRACT

A suspension includes a flexure, a load beam, and a deformation-resistant plate positioned between the flexure and the load beam. The deformation-resistant plate has a holding plate portion for holding a slider through the flexure and a pair of beam portions. The beam portions each have a bent portion bent in a direction approximately perpendicular to the holding plate portion such that the deformation-resistant plate is configured into a three-dimensional structure. The three-dimensional structure of the deformation-resistant plate advantageously resists structural deformation, thus further enables the suspension to possess stable pitch and roll stiffness as well as small yaw stiffness. This not only assists the suspension to have good static performance and improved shock performance, but also assists the slider to rotate easily and to have desirable displacement when the micro-actuator is excited. The present invention also discloses a HGA with the suspension and a drive unit with such HGA.

### FIELD OF THE INVENTION

The present invention relates to an information recording disk drive unit, and more particularly to a suspension for a head gimbal assembly (HGA) with a micro-actuator, a HGA and disk drive unit with the same.

### BACKGROUND OF THE INVENTION

Disk drives are information storage devices that use magnetic media to store data and a movable read/write head positioned over the magnetic media to selectively read data from and write data to the magnetic media.

Consumers are constantly desiring greater storage capacity for such disk drive devices, as well as faster and more accurate reading and writing operations. Thus, disk drive manufacturers have continued to develop higher capacity disk drives by, for example, increasing the recording and reproducing density of the information tracks on the disks by using a narrower track width and/or a narrower track pitch. However, each increase in track density requires that the disk drive device have a corresponding increase in the positional control of the read/write head in order to enable quick and accurate reading and writing operations using the higher density disks. As track density increases, it becomes more and more difficult to quickly and accurately position the read/write head over the desired information tracks on the disk. Thus, disk drive manufacturers are constantly seeking ways to improve the positional control of the read/write head in order to take advantage of the continual increases in track density.

One approach that has been effectively used by disk drive manufacturers to improve the positional control of read/write heads for higher density disks is to employ a dual-stage actuator system. Such dual-stage actuator system typically includes a primary actuator such as a voice-coil motor (VCM) and a secondary micro-actuator such as a piezoelectric (PZT) micro-actuator. The VCM is employed to position the read/write head over desired information track on the storage media. The PZT micro-actuator is used in conjunction with the VCM for the purpose of increasing the positioning access speed and fine tuning the exact position of the read/write head over the desired track. Thus, the VCM makes larger adjustments to the position of the read/write head, while the PZT micro-actuator makes smaller adjustments that fine tune the position of the read/write head relative to the storage media.

Referring to FIGS. 1a and 1b, a conventional disk drive device typically has a drive arm 104, a VCM 105, a HGA 106 attached to and mounted on the drive arm 104, a stack of magnetic disks 101 suspending the HGA 106, and a spindle motor 102 for spinning the disks 101. The HGA 106 includes a slider 103, a PZT micro-actuator 107 with two PZT elements and a suspension 110 to support the slider 103 and the PZT elements of the micro-actuator 107. The suspension 110 comprises a flexure 111, a slider support 112 with a bump 112a formed thereon, a metal base 113 and a load beam 114 with a dimple 114a formed thereon for supporting the slider support 112 and the metal base 113. Specially, the flexure 111 provides a plurality of traces thereon. The traces of the flexure 111 couple the slider support 112 and the metal base 113. The flexure 111 further forms a PZT element attachment region 111a for positioning the two PZT elements of the micro-actuator 107 and a slider attachment region 111b. The slider 103 is partially mounted on the slider support 112 through the slider attachment region 111b with the bump 112a supporting the center of the back surface of the slider 103.

As in the prior art, when a voltage is input to the two thin film PZT elements of the PZT micro-actuator 107, one of the PZT elements may contract while the other may expand. This will generate a rotation torque that causes the slider 103 together with the slider support 112 to rotate against the dimple 114a, which keeps the load force from the load beam 114 evenly applying to the center of the slider 103, thus ensuring the slider 103 a good fly performance, supporting the head with a good flying stability.

However, as the slider support 112 is coupled with the metal base 113 by the traces of the flexure 111 which are only 10-20 um in thickness and formed from soft polymer material, the flexure 111 is easy to distort and accordingly the suspension 110 is likely to deform during suspension manufacture process, HGA manufacturing process and the handle process. Accordingly, the suspension deformation resulted from such weak structure will adversely cause the suspension or HGA dimple separation. FIG. 2a and 2b respectively show a suspension deformation and a dimple separation. Besides, as the slider 103 is partially mounted on the slider support 112 and the slider support 112 is coupled with the metal base 113 via traces of the flexure 111, the static attitude of the slider 103 such as PSA (pitch static attitude) or RSA (roll static attitude) is unstable and difficult to control, which causes the HGA performance unstable and accordingly, affects the HGA dynamic performance seriously, especially when a vibration or shock event happens or during the manufacture process or handle process. Furthermore, such structure makes the whole HGA a poor shock performance. When a vibration or shock event happens, for example tilt drop shock or operation shock, the suspension 110 or the PZT elements of the PZT micro-actuator 107 may be caused to damage.

Hence, it is desired to provide an improved suspension, a HGA with a micro-actuator and a disk drive unit with such HGA to solve the above-mentioned problems and achieve a good performance.

### SUMMARY OF THE INVENTION

Accordingly, an object of the present invention is to provide a suspension for a HGA with improved structures capable of avoiding suspension deformation and dimple separation, thus sufficiently and successfully controlling PSA and RSA stability of the HGA, thereby improving data reading/writing performance of a slider incorporated in the HGA.

Another object of the present invention is to provide a HGA with a suspension which has improved structures capable of avoiding suspension deformation and dimple separation, thus sufficiently and successfully controlling PSA and RSA stability of the HGA, thereby improving data reading/writing performance of a slider incorporated in the HGA.

Still another object of the present invention is to provide a disk drive unit having good static and dynamic performance and improved shock performance.

To achieve the above-mentioned object, the present invention provides a suspension for a HGA. The suspension comprises a flexure, a deformation-resistant plate and a load beam. The flexure has a slider setting portion for mounting a slider, a PZT element setting portion for mounting PZT elements and a neck portion for connecting the PZT element setting portion and the slider setting portion. The deformation-resistant plate has a holding plate portion for holding the slider through the slider setting portion of the flexure and a pair of beam portions formed at two opposite sides of the deformation-resistant plate and coupling to the holding plate portion. The beam portions each have a bent portion bent in a direction approximately perpendicular to the holding plate portion such that the deformation-resistant plate is configured into a three-dimensional structure. The load beam supports the slider setting portion of the flexure by a dimple provided on the load beam.

As an embodiment of the present invention, the bent portion of the deformation-resistant plate is formed at a position juxtaposed with the dimple. Alternatively, the bent portion of the deformation-resistant plate is formed adjacent to a front portion of the holding plate portion.

As embodiments of the present invention, the bent portion of the deformation-resistant plate is U-shaped, V-shaped, arc-shaped, or curve-shaped.

Preferably, the deformation-resistant plate has a rear plate portion welded to the load beam and secured between the flexure and the load beam, and the beam portions extend from a front portion of the holding plate portion to the rear plate portion.

Preferably, the pair of beam portions each comprises a shoulder portion extending sideward and outward from the holding plate portion and an arm portion extending perpendicularly to the shoulder portion. Also preferably, the bend portion is formed on the arm portion.

A HGA for a disk drive unit of the present invention comprises a slider, a micro-actuator and a suspension for supporting the slider and the micro-actuator. The suspension comprises a flexure, a deformation-resistant plate and a load beam. The flexure has a slider setting portion for mounting the slider, a PZT element setting portion for mounting PZT elements and a neck portion for connecting the PZT element setting portion and the slider setting portion. The deformation-resistant plate has a holding plate portion for holding the slider through the slider setting portion of the flexure and a pair of beam portions formed at two opposite sides of the deformation-resistant plate and coupling to the holding plate portion. The beam portions each have a bent portion bent in a direction approximately perpendicular to the holding plate portion such that the deformation-resistant plate is configured into a three-dimensional structure. The load beam supports the slider setting portion of the flexure by a dimple provided on the load beam.

A disk drive unit of the present invention comprises a HGA, a drive arm to connect the HGA, a disk and a spindle motor to spin the disk. The HGA comprises a slider, a micro-actuator and a suspension for supporting the slider and the micro-actuator. The micro-actuator includes PZT elements. The suspension comprises a flexure, a deformation-resistant plate and a load beam. The flexure has a slider setting portion for mounting the slider, a PZT element setting portion for mounting the PZT elements and a neck portion for connecting the PZT element setting portion and the slider setting portion. The deformation-resistant plate has a holding plate portion for holding the slider through the slider setting portion of the flexure and a pair of beam portions formed at two opposite sides of the deformation-resistant plate and coupling to the holding plate portion. The beam portions each have a bent portion bent in a direction approximately perpendicular to the holding plate portion such that the deformation-resistant plate is configured into a three-dimensional structure. The load beam supports the slider setting portion of the flexure by a dimple provided on the load beam.

In comparison with the prior art, the whole arrangement of the deformation-resistant plate configured into a three-dimensional structure advantageously resists structural deformation and accordingly successfully prevents the flexure distortion and assists the HGA with the flexure to avoid suspension deformation as well as dimple separation. Stated another way, the deformation-resistant plate enables the suspension to possess stable pitch and roll stiffness, which favorably assists the HGA to have good static performance, such as a favorable capability of PSA/RSA control, and improved shock performance. Besides, the structure of the suspension mentioned above also provides the HGA with substantially small yaw stiffness, which accordingly assists the slider to rotate easily and to have desirable displacement when the micro-actuator is excited, thus improves dynamic performance of the HGA.

Other aspects, features, and advantages of this invention will become apparent from the following detailed description when taken in conjunction with the accompanying drawings, which are a part of this disclosure and which illustrate by way of example, principles of this invention.

### BRIEF DESCRIPTION OF THE DRAWINGS

The accompanying drawings facilitate an understanding of the various embodiments of this invention. In such drawings:

FIG. 1a is a perspective view of a conventional disk drive unit;

FIG. 1b is an exploded, perspective view of a conventional HGA with thin film micro-actuator used in the disk drive unit of FIG. 1a;

FIG. 2a is a diagrammatic view illustrating a suspension deformation problem of the conventional HGA with the thin film micro-actuator;

FIG. 2b is a diagrammatic view illustrating a dimple separation problem of the conventional HGA with the thin film micro-actuator;

FIG. 3 is a perspective view of a HGA with a PZT micro-actuator according to the present invention,

FIG. 4 is a partially enlarged perspective view of the HGA of FIG. 3, showing a tongue region of the HGA;

FIG. 5 is a perspective view of a flexure of the HGA shown in FIG. 4;

FIG. 6 is a perspective view of a deformation-resistant plate of the HGA shown in FIG. 4;

FIG. 7 is a partial side elevational view of the HGA shown in FIG. 4, and;

FIG. 8 is a perspective view of a disk drive unit according to the present invention.

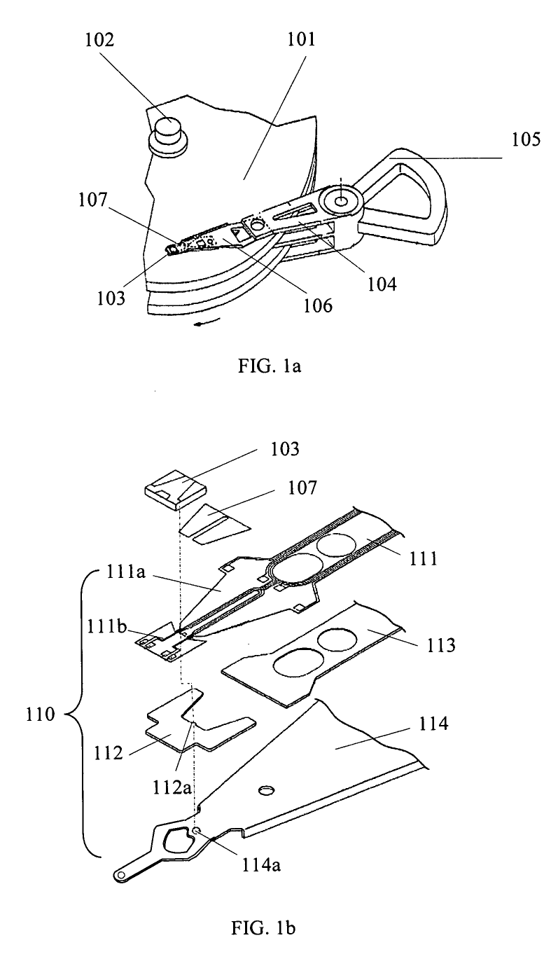

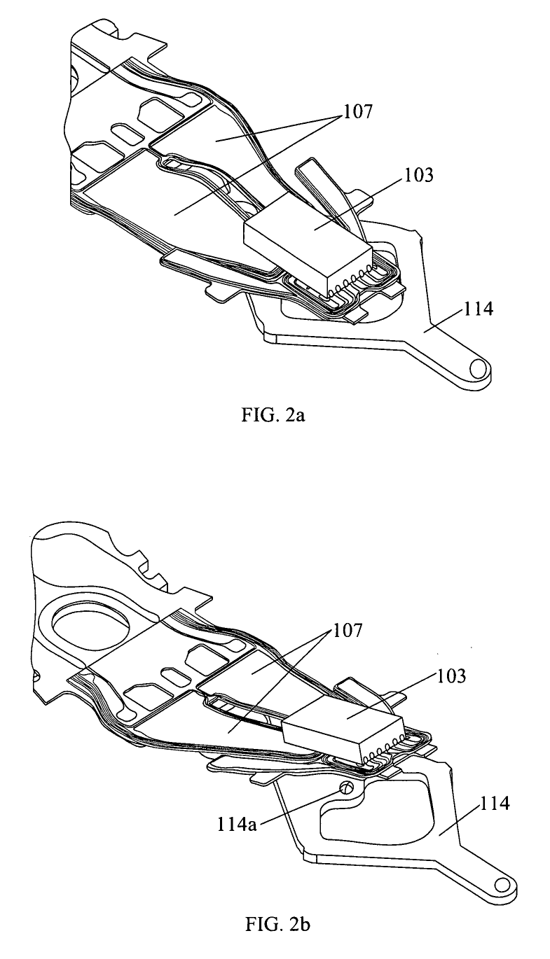

### DETAILED DESCRIPTION OF ILLUSTRATED EMBODIMENTS

Various preferred embodiments of the invention will now be described with reference to the figures, wherein like reference numerals designate similar parts throughout the various views. As indicated above, the invention is directed to a suspension for suspending a slider that performs at least one of a recording and a reproduction of information with respect to a recording medium. The suspension comprises a flexure, a deformation-resistant plate and a load beam. The deformation-resistant plate has a holding plate portion for holding a slider through a slider setting of the flexure and a pair of beam portions formed at two opposite sides of the deformation-resistant plate and coupling to the holding plate portion. The beam portions each have at least one bent portion bent in a direction approximately perpendicular to the holding plate portion such that the deformation-resistant plate is configured into a three-dimensional structure. The whole arrangement of the deformation-resistant plate advantageously resists structural deformation and accordingly successfully prevents flexure distortion and assists a HGA with the flexure to avoid suspension deformation as well as dimple separation. Further, the deformation-resistant plate enables the suspension to possess stable pitch and roll stiffness, which favorably assists the HGA to have good static performance, such as a favorable capability of PSA/RSA control, and improved shock performance. Besides, the structure of the suspension mentioned above also provides the HGA with substantially small yaw stiffness, which accordingly assists the slider to rotate easily and to have desirable displacement when the micro-actuator is excited, thus improves dynamic performance of the HGA.

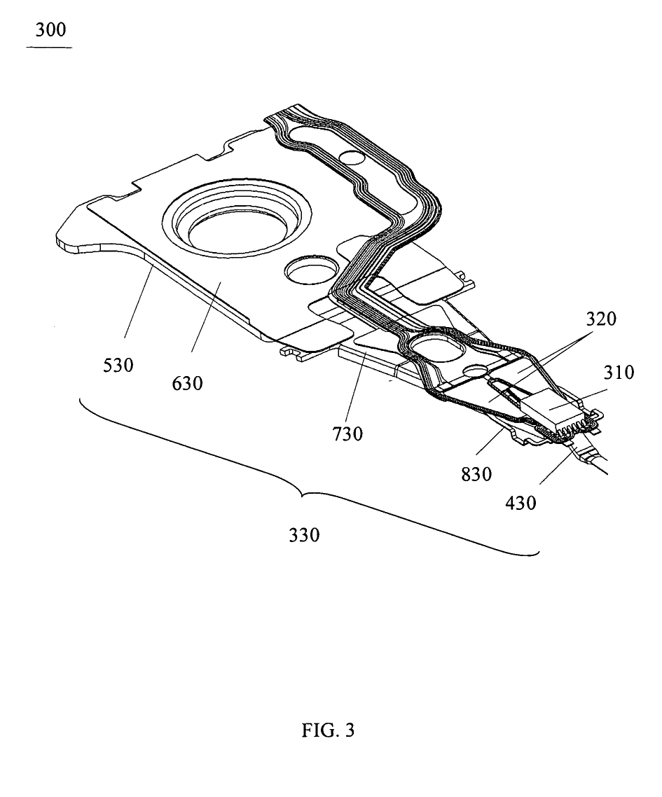

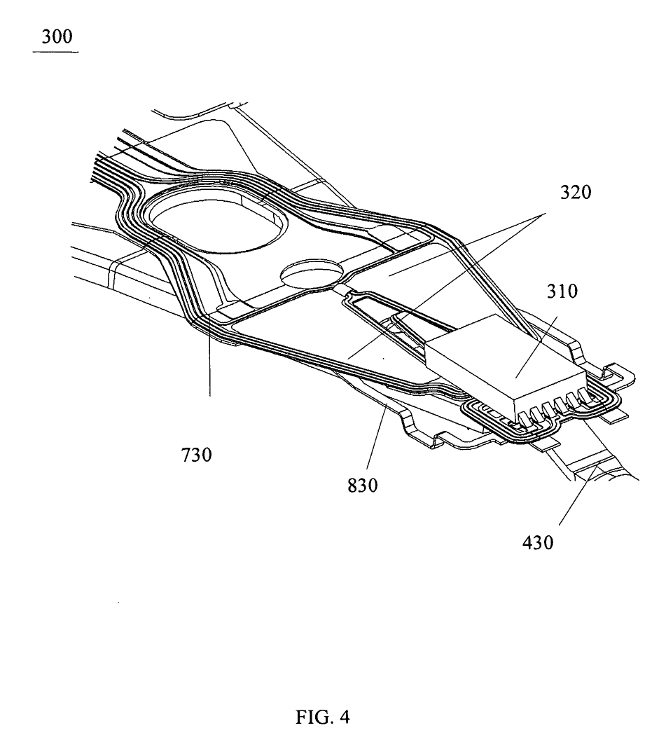

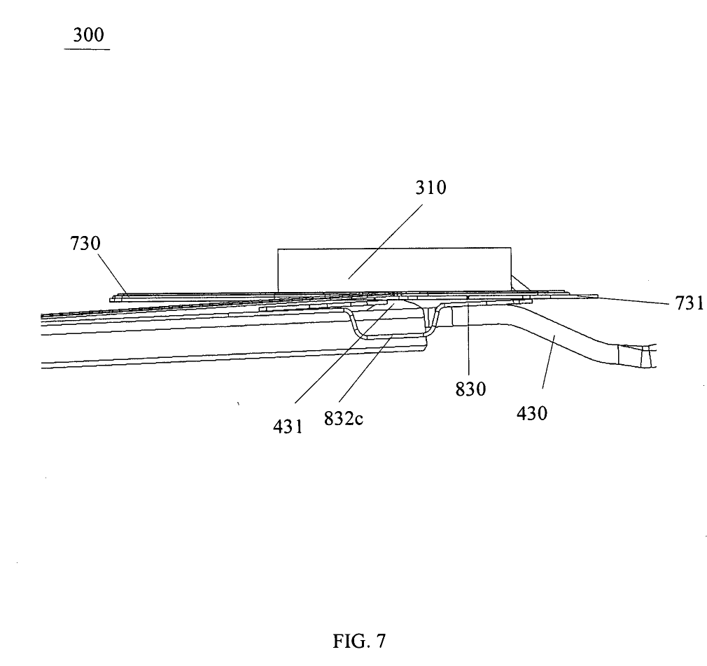

FIGS. 3-7 illustrate an embodiment of a HGA 300 according to the present invention. Referring to FIGS. 3 and 4, the HGA 300 generally comprises a slider 310 with a plurality of slider electrical pads (not labeled), two PZT elements 320 of a micro-actuator with a plurality of PZT electrical pads (not labeled), and a suspension 330 to load or support the slider 310 and the PZT elements 320. The suspension 330 includes a base plate 530, a hinge 630, a flexure 730, a deformation-resistant plate 830 and a load beam 430, all of which are assembled together. The deformation-resistant plate 830 is disposed between the flexure 730 and the load beam 430. The load beam 430 is connected to the base plate 530 by the hinge 630, and the flexure 730 runs from the hinge 630 to the load beam 430. One end of the load beam 430 is coupled to the base plate 530 which is swaged to the drive arm (not shown), and the other end of the load beam 430 supports a tongue region of the flexure 730. The tongue region of the flexure 730 provides flexibility for the slider 310. In order to smoothly and evenly transfer the load force from the load beam 430 to the slider 310, the load beam 430 provides a dimple 431 (shown in FIG. 7) to support the tongue region of the flexure 730 at a position where the slider 310 is mounted.

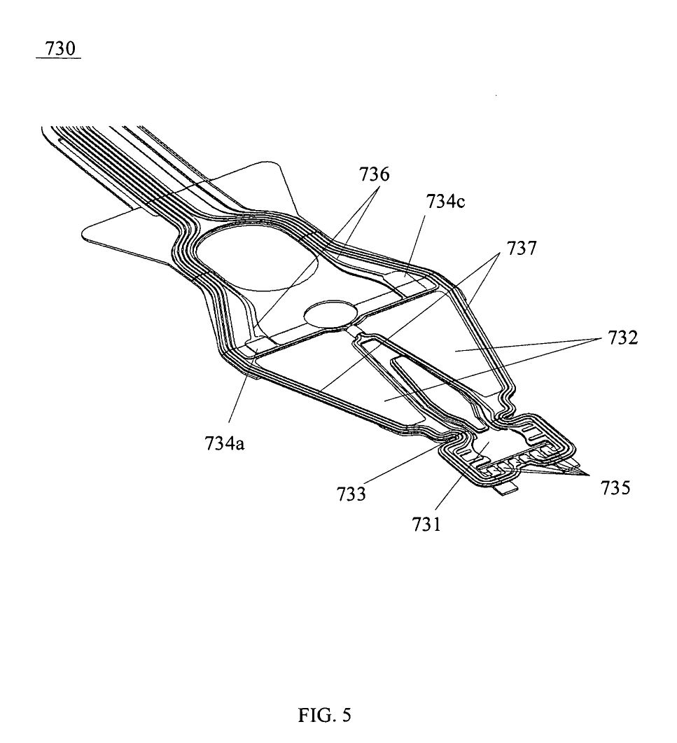

Referring to FIG. 5, the tongue region of the flexure 730 comprises a slider setting portion 731 for mounting the slider 310, a PZT element setting portion 732 for mounting the PZT elements 320, and a neck portion 733 for connecting the PZT element setting portion 732 with the slider setting portion 731. The neck portion 733 is far narrower than the slider setting portion 731 and the PZT element setting portion 732 so that the slider setting portion 731 is able to be rotated about the neck portion 733 when the micro-actuator is excited. In addition, the flexure 730 further has a plurality of flexure-PZT electrical pads 734a, 734c, a plurality of flexure-slider electrical pads 735 and two sets of electrical traces 736, 737 in the tongue region. The plurality of flexure-PZT electrical pads 734a, 734c is formed corresponding to the PZT electrical pads of the PZT elements 320 of the micro-actuator and the plurality of flexure-slider electrical pads 735 is formed corresponding to the slider electrical pads of the slider 310. The flexure 730 and the PZT elements 320 are electrically connected to a common ground.

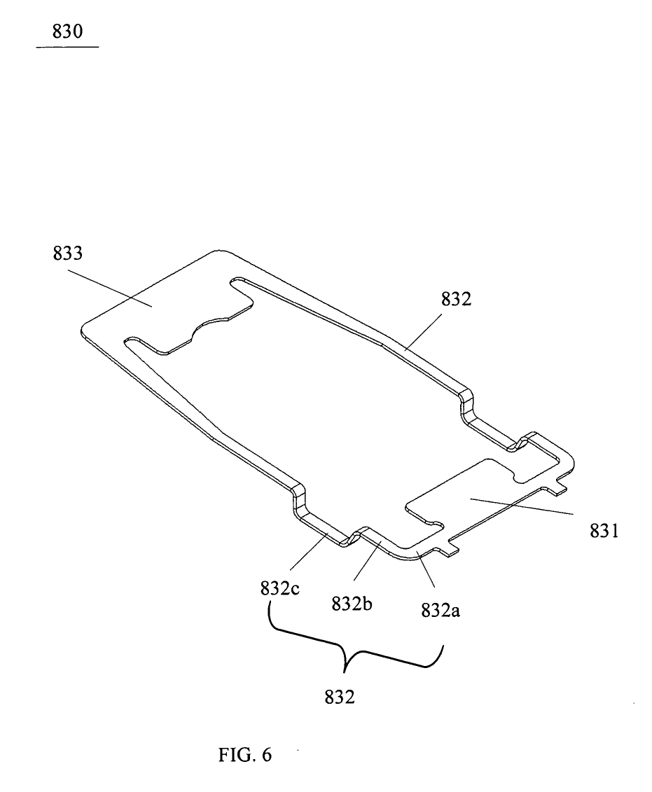

Referring to FIG. 6, the deformation-resistant plate 830 of the HGA 300 according to the present embodiment comprises a holding plate portion 831, a pair of beam portions 832 and a rear plate portion 833. The pair of beam portions 832 are formed at two opposite sides of the deformation-resistant plate 830 and coupled to the holding plate portion 831. The rear plate portion 833 is welded to the load beam 430 and secured between the flexure 730 and the load beam 430, and the beam portions 832 extend from a front portion of the holding plate portion 831 to the rear plate portion 833.

The beam portions 832 each have a shoulder portion 832a, an arm portion 832b and a bent portion 832c. The shoulder portion 832a extends sideward and outward from the holding plate portion 831 while the arm portion 832b extends perpendicularly to the shoulder portion 832a. The bend portion 832b is formed on the arm portion 832b. Specifically, the bent portion 832c bends in a direction approximately perpendicular to the holding plate portion 831 such that the deformation-resistant plate 830 is configured into a three-dimensional structure.

In the subject embodiment, the bent portion 832c of the deformation-resistant plate 830 is formed at a position juxtaposed with the dimple 431 of the load beam 430, as best shown in FIG. 7. It will be appreciated that, alternatively, the bent portion 832c of the deformation-resistant plate 830 can be formed adjacent to a front portion of the holding plate portion 831. As shown in FIG. 6, the bent portion 832c is U-shaped. It will be appreciated that, alternatively, the bent portion 832c can also be shaped as other shape, such as V-shape, arc-shape or curve-shape. Also it is understood that the deformation-resistant plate 830 according to the present invention may form a plurality of bend portions 832c of such structure.

Turning now to FIGS. 3-6, the slider 310 is mounted in such a way as the slider setting portion 731 of the flexure 730 supporting the slider 310 and the holding plate portion 831 of the deformation-resistant plate 830 holding the slider 310 through the slider setting portion 731. The two PZT elements 320 of the micro-actuator are respectively arranged at the PZT element setting portion 732 of the flexure 730. Some electrical bonding methods, such as soldering or wire bonding or other suitable method, are used for electrical connection between the flexure 730 and the slider 310 via the flexure-slider electrical pads 735 and the slider electrical pads as well as between the flexure 730 and the PZT elements 320 via the flexure-PZT electrical pads 734a, 734c and the PZT electrical pads. One end of the traces 736, 737 formed on the flexure 730 connects with the PZT electrical pads of the PZT elements 320a and the slider electrical pads of the slider 310, and the other end connects with the control system through the suspension pads (not shown). Thus the control system can respectively control the micro-actuator and the slider 310 via traces 736, 737.

FIG. 7 is a partial side elevational view of the HGA 300 of FIG. 4. The slider 310 is mounted on the slider setting portion 731 of the flexure 730 with the deformation-resistant plate 830 holding the slider 310 through the slider setting portion 731. The dimple 431 of the load beam 430 supports the slider setting portion 731 of the flexure 730. When the slider 310 is flying on the disk (not shown), the dimple 431 keeps the load force from the load beam 430 always evenly applying to the center of the slider 310, thus ensuring the slider 310 a good fly performance. In the subject embodiment, the introduction of the bent portion 832c of the subject embodiment enables the deformation-resistant plate 830 to form a three-dimensional structure, which advantageously resists structural deformation and further enables the suspension to possess stable pitch and roll stiffness and small yaw stiffness. Furthermore, such reliable configuration of the suspension assists the slider to have desirable displacement and to rotate easily when the micro-actuator is excited.

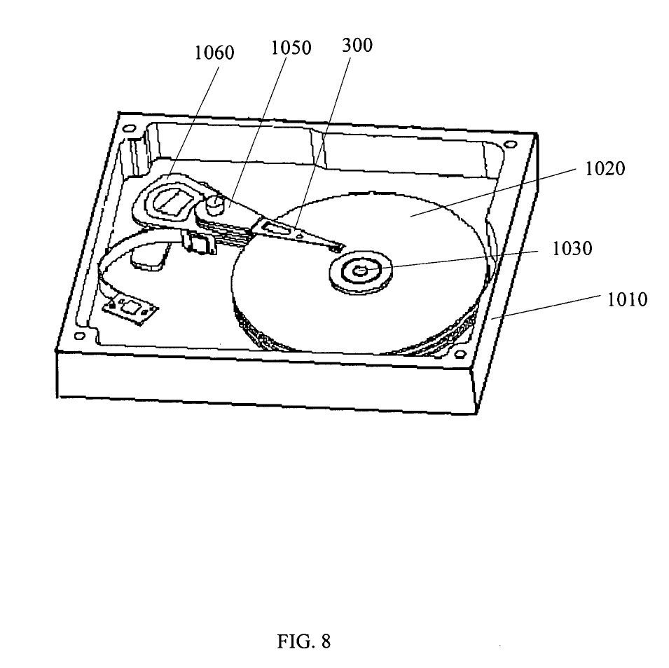

Referring to FIG. 8, according to an embodiment of the present invention, a disk drive unit can be attained by assembling a base 1010, a disk 1020, a spindle motor 1030 for spinning the disk 1020, a VCM 1060, and a drive arm 1050 with the HGA 300. Because the structure and/or assembly process of the disk drive unit of the present invention are well known to persons ordinarily skilled in the art, a detailed description of such structure and assembly is omitted herefrom.

The foregoing description of the present invention has been presented for purposes of illustration and description. It is not intended to be exhaustive or limit the invention to the precise form disclosed, and obviously many modifications and variations are possible in light of the above teaching. Such modifications and variations that may be apparent to those skilled in the art are intended to be included within the scope of this invention as defined by the accompanying claims.

What is claimed is:

1. A suspension for a head gimbal assembly comprising:
a flexure having a slider setting portion for mounting a slider, a piezoelectric element setting portion for mounting piezoelectric elements, and a neck portion for connecting the piezoelectric element setting portion with the slider setting portion;
a deformation-resistant plate having a holding plate portion for holding the slider through the slider setting portion of the flexure and a pair of beam portions formed at two opposite sides of the deformation-resistant plate and coupling to the holding plate portion, the beam portions each having at least one bent portion bent in a direction approximately perpendicular to the holding plate portion such that the deformation-resistant plate is configured into a three-dimensional structure; and
a load beam for supporting the slider setting portion of the flexure by a dimple provided on the load beam.

2. The suspension according to claim 1, wherein the bent portion of the deformation-resistant plate is formed at a position juxtaposed with the dimple.

3. The suspension according to claim 1, wherein the bent portion of the deformation-resistant plate is formed adjacent to a front portion of the holding plate portion.

4. The suspension according to claim 1, wherein the bent portion of the deformation-resistant plate is U-shaped, V-shaped, arc-shaped, or curve-shaped.

5. The suspension according to claim 1, wherein the deformation-resistant plate further has a rear plate portion welded to the load beam and secured between the flexure and the load beam, and the beam portions extend from a front portion of the holding plate portion to the rear plate portion.

6. The suspension according to claim 1, wherein the pair of beam portions each comprises a shoulder portion extending sideward and outward from the holding plate portion and an arm portion extending perpendicularly to the shoulder portion.

7. The suspension according to claim 6, wherein the bend portion is formed on the arm portion.

8. A head gimbal assembly for a disk drive unit, comprising:
a slider;
a micro-actuator having piezoelectric elements; and
a suspension for supporting the slider and the micro-actuator, the suspension comprising a flexure, a deformation-resistant plate and a load beam, the flexure having a slider setting portion for mounting the slider, a piezoelectric element setting portion for mounting the piezoelectric elements and a neck portion for connecting the piezoelectric element setting portion and the slider setting portion, the deformation-resistant plate having a holding plate portion for holding the slider through the slider setting portion of the flexure and a pair of beam portions formed at two opposite sides of the deformation-resistant plate and coupling to the holding plate portion, the beam portions each having at least one bent portion bent in a direction approximately perpendicular to the holding plate portion such that the deformation-resistant plate is configured into a three-dimensional structure, the load beam supporting the slider setting portion of the flexure by a dimple provided on the load beam.

9. The head gimbal assembly according to claim 8, wherein the bent portion of the deformation-resistant plate is formed at a position juxtaposed with the dimple.

10. The head gimbal assembly according to claim 8, wherein the bent portion of the deformation-resistant plate is formed adjacent to a front portion of the holding plate portion.

11. The head gimbal assembly according to claim 8, wherein the bent portion of the deformation-resistant plate is U-shaped, V-shaped, arc-shaped, or curve-shaped.

12. The head gimbal assembly according to claim 8, wherein the deformation-resistant plate further has a rear plate portion welded to the load beam and secured between the flexure and the load beam, and the beam portions extend from a front portion of the holding plate portion to the rear plate portion.

13. The head gimbal assembly according to claim 8, wherein the pair of beam portions each comprises a shoulder portion extending sideward and outward from the holding plate portion and an arm portion extending perpendicularly to the shoulder portion.

14. The head gimbal assembly according to claim 13, wherein the bend portion is formed on the arm portion.

15. A disk drive unit comprising:
a head gimbal assembly;
a drive arm to connect the head gimbal assembly;
a disk; and
a spindle motor to spin the disk;
wherein the head gimbal assembly comprises:
a slider; and
a micro-actuator having piezoelectric elements; and
a suspension for supporting the slider and the micro-actuator, the suspension comprising a flexure, a deformation-resistant plate and a load beam, the flexure having a slider setting portion for mounting the slider, a piezoelectric element setting portion for mounting the piezoelectric elements and a neck portion for connecting the piezoelectric element setting portion and the slider setting portion, the deformation-resistant plate having a holding plate portion for holding the slider through the slider setting portion of the flexure and a pair of beam portions formed at two opposite sides of the deformation-resistant plate and coupling to the holding plate portion, the beam portions each having at least one bent portion bent in a direction approximately perpendicular to the holding plate portion such that the deformation-resistant plate is configured into a three-dimensional structure, the load beam supporting the slider setting portion of the flexure by a dimple provided on the load beam.

16. The disk drive unit according to claim 15, wherein the bent portion of the deformation-resistant plate is formed at a position juxtaposed with the dimple.

17. The disk drive unit according to claim 15, wherein the bent portion of the deformation-resistant plate is U-shaped, V-shaped, arc-shaped, or curve-shaped.

18. The disk drive unit according to claim 15, wherein the deformation-resistant plate further has a rear plate portion welded to the load beam and secured between the flexure and the load beam, and the beam portions extend from a front portion of the holding plate portion to the rear plate portion.

19. The disk drive unit according to claim 15, wherein the pair of beam portions each comprises a shoulder portion extending sideward and outward from the holding plate portion and an arm portion extending perpendicularly to the shoulder portion.

20. The disk drive unit according to claim 19, wherein the bend portion is formed on the arm portion.
